(19) United States
(12) Patent Application Publication
(10) Pub. No.: US 2014/0062323 A1
(43) Pub. Date: Mar. 6, 2014

(54) Linear Light-Emitting Diode Driving Circuit with Voltage-Lowering Serial Capacitor

(71) Applicant: Luxul Technology Incorporation, New Taipei City (TW)

(72) Inventors: Cheng-Hung Pan, New Taipei City (TW); Perng-Fei Yuh, New Taipei City (TW)

(73) Assignee: Luxul Technology Incorporation, New Taipei City (TW)

(21) Appl. No.: 13/973,087

(22) Filed: Aug. 22, 2013

(30) Foreign Application Priority Data
Aug. 28, 2012 (TW) 101131092

(51) Int. Cl. H05B 33/08

(52) U.S. Cl. CPC H05B 33/0806
USPC 315/200 R

(57) ABSTRACT

A linear light-emitting diode (LED) driving circuit with voltage-lowering serial capacitor has a rectification unit, an LED unit, a constant current controller, a series and parallel voltage divider and a controller. The controller is built in with a safe voltage threshold, controls the series and parallel voltage divider to be connected in series to the LED unit when an output voltage of the rectification unit exceeds the safe voltage threshold, ensuring that an average voltage across the LED unit and the constant current controller is stable, and controls the series and parallel voltage divider to be parallelly connected across the LED unit and the ground when the output voltage of the rectification unit does not exceed the safe voltage threshold. Accordingly, a safety standard of voltage for LED driving circuit can be secured and users' safety can be ensured.

### BACKGROUND OF THE INVENTION

1. Field of the Invention

The present invention relates to a linear light-emitting diode (LED) driving circuit, and more particularly to a linear LED driving circuit with voltage-lowering serial capacitor.

2. Description of the Related Art

LEDs are the commonly used lighting devices in the current market. In contrast to conventional incandescent lamps, LEDs feature high light emitting efficiency, low power consumption and low pollution. As LEDs can only be turned on by power flowing in one direction through them, the LED industry has thus developed a conventional linear LED driving circuit as shown in FIG. 8 to tackle this regard. The conventional linear LED driving circuit has a rectification unit 50, an LED unit 51, and a constant current controller 52.

The rectification unit is connected to an AC power source (AC/IN) and converts the AC power into a pulsed DC power.

The LED unit 51 is connected with the rectification unit in series and has multiple LED light sources.

The constant current controller 52 is connected to the LED unit 51 in series to form a power loop, and controls current flowing through the LED unit 51 at a constant value.

After the rectification unit 50 converts the AC power into the pulsed DC power, the constant current controller 52 stabilizes the current flowing through the LED unit 51 so that the LED unit 51 can steadily emit light.

Currently, European countries regulate that the driving voltage of any exposed electronic element outside a housing of an electric/electronic appliance should not exceed 48 V, aiming to avoid occurrence of electric shock when users inadvertently contact the exposed electronic element during operation of the electric/electronic appliance. Hence, the LED unit 51 external to the conventional LED driving circuit employs the voltage of 48 V, which is harmless to human body. The conventional LED driving circuit has a transformer connected in series between the rectification unit 50 and the AC power source (AC/IN) to lower voltage and make the voltage across an LED lamp in compliance with the safety standard of the voltage.

Furthermore, as voltage values of AC power sources vary according to countries and regions in the world, different transformers are adopted to convert different voltage values of AC power sources and output a specific DC voltage for the conventional LED driving circuit to be normally operated. As a result, manufacturers of the conventional LED driving circuit must prepare many kinds of LED driving circuits for different AC power sources. Besides, the transformer used to lower voltage tends to be bulkier than regular electronic elements. The diversity and bulkiness of the transformer pose pressure on the manufacturers in warehousing management. On the other hand, consumers also need to purchase the right LED driving circuits meeting specifications of the local mains power. Otherwise, wrongly selected LED driving circuits operated at low voltages will be damaged when connected to high-voltage AC power sources.

### SUMMARY OF THE INVENTION

An objective of the present invention is to provide a linear LED driving circuit with voltage-lowering serial capacitor eliminating the use of transformer and being adaptable to multiple AC power sources.

To achieve the foregoing objective, the linear LED driving circuit with voltage-lowering serial capacitor has a rectification unit, a light-emitting diode (LED) unit, a constant current controller, a first series and parallel voltage divider, and a voltage-dividing controller.

The rectification unit is adapted to connect to an AC power source and convert the AC power into a pulsed DC power.

The LED unit is connected in series to the rectification unit, and has multiple LED light sources.

The constant current controller is connected in series to the LED unit and the ground to form a power loop, and maintains current flowing through the LED unit at a constant value.

The first series and parallel voltage divider is connected between the rectification unit and the LED unit, is operated under a series connection mode or a parallel connection mode, and has a first voltage-dividing capacitor. The first voltage-dividing capacitor is connected in series between the rectification unit and the LED unit during the series connection mode and is parallelly connected across the LED unit and the ground during the parallel connection mode.

The voltage-dividing controller is built in with a safe voltage threshold, is connected to the rectification unit and the first series and parallel voltage divider, detects a voltage value of the pulsed DC power outputted from the rectification unit, and controls the first series and parallel voltage divider to be operated under the series connection mode when the voltage value of the pulsed DC power exceeds the safe threshold and to be operated under the parallel connection mode when the voltage value of the pulsed DC power does not exceed the safe voltage threshold.

As the first series and parallel voltage divider is connected between the rectification unit and the LED unit and the voltage-dividing controller controls the first series and parallel voltage divider to be connected in series or parallelly to the LED unit and the constant current controller, the first voltage-dividing capacitor is connected in series to the LED unit when the voltage value of the pulsed DC power exceeds the safe voltage threshold. The portion of the voltage value of the pulsed DC power higher than the safe voltage threshold is dropped across the first voltage-dividing capacitor of the first series and parallel voltage divider to ensure that the average voltage across the LED unit and the constant current controller is stable. The present invention uses the first series and parallel voltage divider to replace a bulky transformer, and ensures the compliance of the LED driving circuit with a corresponding safety standard and users' safety.

To achieve the foregoing objective, the linear LED driving circuit with voltage-lowering serial capacitor further has at least one second series and parallel voltage divider.

The at least one second series and parallel voltage divider is connected between the rectification unit and the first series and parallel voltage divider, and is operated under the series connection mode or the parallel connection mode. Each one of the at least one second series and parallel voltage divider has a second voltage-dividing capacitor.

The second voltage-dividing capacitor is connected in series between the rectification unit and the first series and parallel voltage divider during the series connection mode and is parallelly connected across the LED unit and the ground during the parallel connection mode.

The voltage-dividing controller is connected to the at least one second series and parallel voltage divider, is built in with at least one voltage switching threshold being not less than the safe voltage threshold and adapted to correspond to a voltage value of at least one AC power source, and controls the second series and parallel voltage divider to be operated under the series connection mode when the voltage value of the pulsed DC power exceeds the at least one voltage switching threshold and operated under the parallel connection mode when the voltage value of the pulsed DC power does not exceed the at least one voltage switching threshold.

The present invention increases the total number of the series-connected voltage-dividing capacitors through the series connection mode of the first series and parallel voltage divider and the second series and parallel voltage divider to be adaptable to the use with AC power sources with higher voltage. When the voltage value of the pulsed DC power exceeds the safe voltage threshold and the voltage switching threshold, the first voltage-dividing capacitor of the first series and parallel voltage divider and the second voltage-dividing capacitor of the second series and parallel voltage divider are connected to the LED unit, and the portion of the voltage of the pulsed DC power higher than the safe voltage threshold and the voltage switching threshold is dropped across the first voltage-dividing capacitor and the second voltage-dividing capacitor to ensure that an average voltage across the LED unit and the constant current controller is stable.

Other objectives, advantages and novel features of the invention will become more apparent from the following detailed description when taken in conjunction with the accompanying drawings.

### BRIEF DESCRIPTION OF THE DRAWINGS

FIG. 1 is a circuit diagram of a first embodiment of a linear LED driving circuit with voltage-lowering serial capacitor in accordance with the present invention;

FIG. 2 is a circuit diagram of the linear LED driving circuit using a switching diode in FIG. 1;

FIG. 3 is a waveform diagram of the linear LED driving circuit in FIG. 2;

FIG. 4 is a circuit diagram of a second embodiment of a linear LED driving circuit using two switching diodes in accordance with the present invention;

FIG. 5 is a waveform diagram of the linear LED driving circuit in FIG. 4;

FIG. 6 is another waveform diagram of the linear LED driving circuit in FIG. 4;

FIG. 7 is a circuit diagram of a third embodiment of a linear LED driving circuit using multiple switching diodes in accordance with the present invention; and

FIG. 8 is a block circuit diagram of a conventional LED driving circuit.

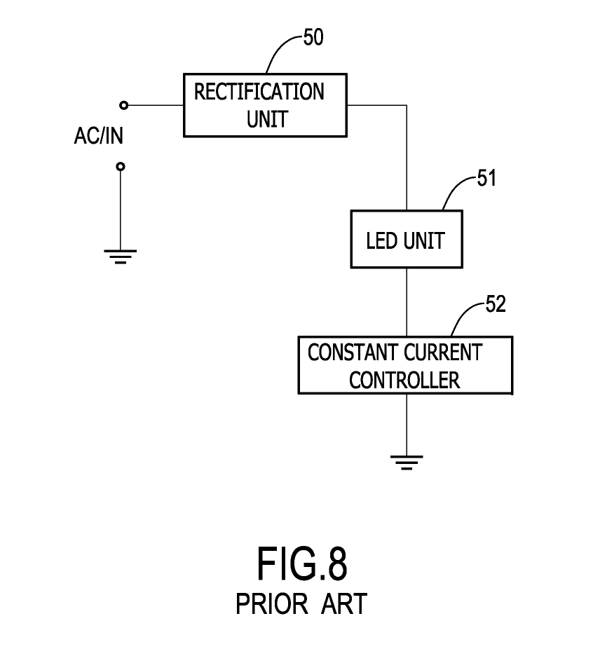

### DETAILED DESCRIPTION OF THE INVENTION

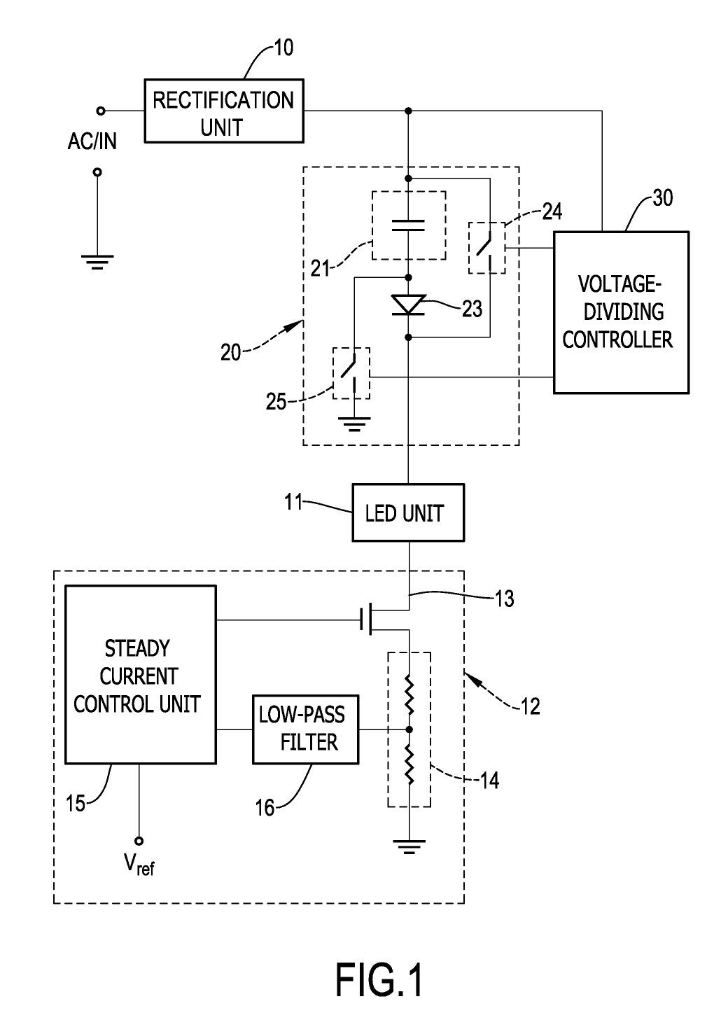

With reference to FIG. 1, a first embodiment of a linear LED driving circuit with voltage-lowering serial capacitor in accordance with the present invention has a rectification unit 10, an LED unit 11, a constant current controller 12, a first series and parallel voltage divider 20 and a voltage-dividing controller 30.

The rectification unit 10 is connected to an AC power source (AC/IN) to convert the AC power into a pulsed DC power. In the present embodiment, the rectification unit 10 is a full-wave rectifier.

The LED unit 11 is connected in series with the rectification unit 10, and has multiple LED light sources.

The constant current controller 12 is connected in series with the LED unit 11 to form a power loop, and maintains current flowing through the LED unit 11 at a constant value. In the present embodiment, the constant current controller 12 has a voltage-controlled transistor 13, a current-detecting unit 14, and a steady current control unit 15. The current-detecting unit 14 is connected in series with the voltage-controlled transistor 13. The current-detecting unit 14 and the voltage-controlled transistor 13 are connected to the LED unit 11 to form the power loop. The current-detecting unit 14 detects current flowing through the power loop and transmits current signals detected by a low-pass filter 16 to the steady current control unit 15. The steady current control unit 15 feeds back the current flowing through the power loop via the voltage-controlled transistor 13 according to the current signal for the current through the power loop to approach a steady state.

The first series and parallel voltage divider 20 is connected between the rectification unit 10 and the LED unit 11, is operated under a series connection mode or a parallel connection mode, and has a voltage-dividing capacitor 21. During the series connection mode, the voltage-dividing capacitor 21 is connected in series between the rectification unit 10 and the LED unit 11. During the parallel connection mode, the voltage-dividing capacitor 21 is parallelly connected across the LED unit 11 and the ground. In the present embodiment, the voltage-dividing capacitor 21 has a positive end and a negative end. The first series and parallel voltage divider 20 further has a control diode 23, a first mode selection switch 24, and a second mode selection switch 25.

The control diode 23 is connected in series to the voltage-dividing capacitor 21, and has an anode and a cathode. The anode of the control diode 23 is connected to the negative end of the voltage-dividing capacitor 21.

The first mode selection switch 24 has two terminals. One terminal of the first mode selection switch 24 is connected to the positive end of the voltage-dividing capacitor 21, and the other terminal is connected to the LED unit 11.

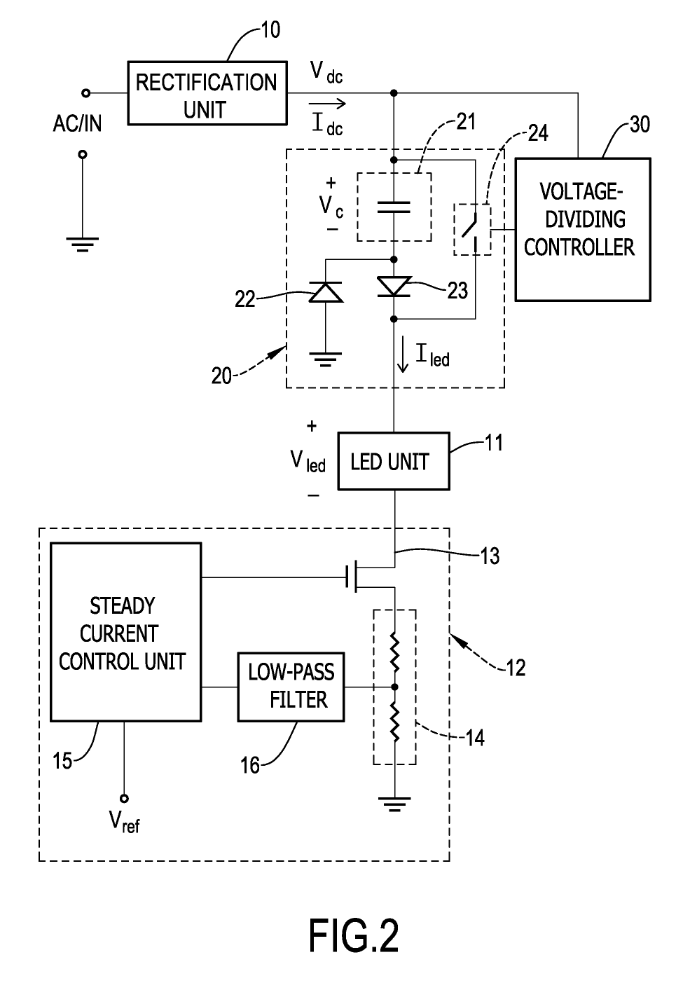

The second mode selection switch 25 has two terminals. One terminal of the second mode selection switch 25 is connected to a series-connected node between the voltage-dividing capacitor 21 and the control diode 23, and the other terminal is connected to the ground. With reference to FIG. 2, the second mode selection switch 25 is a switching diode 22 whose cathode is connected to a series-connected node between the voltage-dividing capacitor 21 and the control diode 23 and whose anode is connected to the ground.

The voltage-dividing controller 30 is built in with a safe voltage threshold Vₛₑₜ, and is connected to the rectification unit 10 and the first series and parallel voltage divider. The voltage-dividing controller 30 detects a voltage value V_{dc} of the pulsed DC power outputted from the rectification unit 10. The first series and parallel voltage divider 20 is controlled and operated under the series connection mode or the parallel connection mode when the voltage value V_{dc} exceeds or does not exceed the safe voltage threshold Vₛₑₜ. In the present embodiment, the voltage-dividing controller 30 is connected to the first mode selection switch 24 and the second mode selection switch 25, and the first mode selection switch 24 and the second mode selection switch 25 are turned off or turned on when the voltage value V_{dc} exceeds or does not exceed the safe voltage threshold Vₛₑₜ.

It is stressed that in contrast to the means of conventional switch cap DC-to-DC converter, the first mode selection switch 24 and the second mode selection switch 25 are controlled according to the embedded safe voltage threshold Vₛₑₜ. The turn-on and turn-off frequencies of the first and second mode selection switches 24, 25 are consistent with the frequency of the inputted AC power. Hence, the turn-on and turn-off operations of the first and second mode selection switches 24, 25 result in no asynchronous wave interference, and no high-speed system clock is required to turn on or off the first mode selection switch 24 and the second mode selection switch 25.

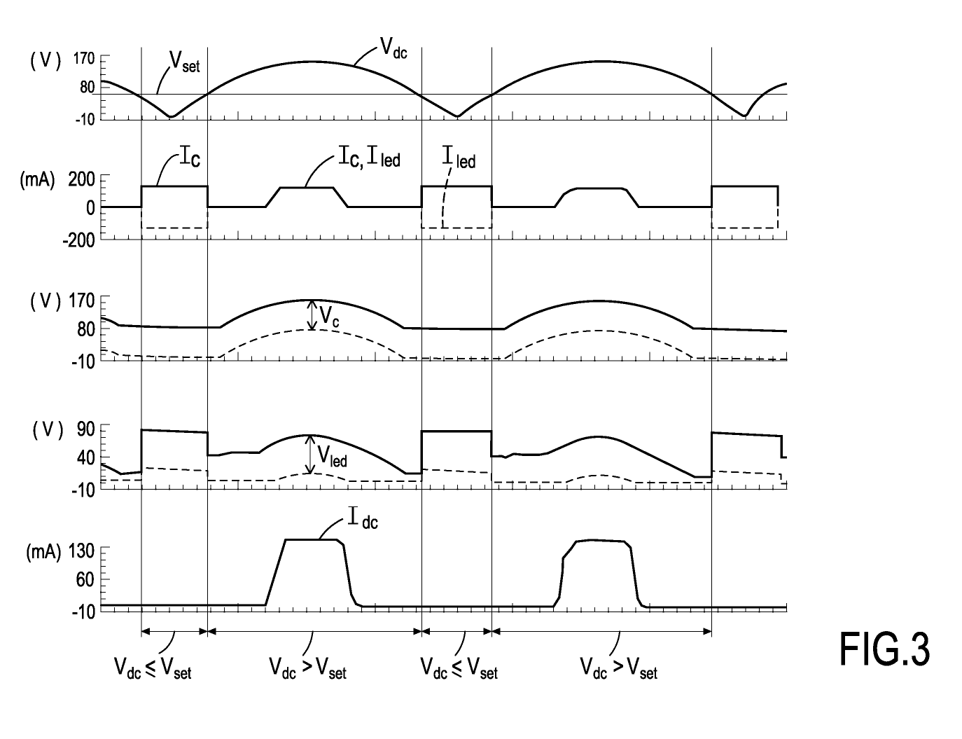

With reference to FIG. 3, suppose that an effective voltage value of the AC power source is 110 V and the safe voltage threshold Vₛₑₜ is 48 V in the foregoing embodiment. When the voltage value V_{dc} of the pulsed DC power is greater than the safe voltage threshold Vₛₑₜ, the voltage-dividing controller 30 enables the first mode selection switch 24 to turn off. As the switching diode 22 of the second mode selection switch 25 is reverse-biased at the same time, the second mode selection switch 25 is also turned off. Therefore, the voltage-dividing capacitor 21 series-connected between the rectification unit 10 and the LED unit 11 is charged by the pulsed DC power and lowers the voltage to the LED unit 11.

When the voltage value V_{dc} is not greater than the safe voltage threshold Vₛₑₜ, the first mode selection switch 24 is enabled to turn on. As the switching diode 22 of the second mode selection switch 25 is forward-biased at the same time, the second mode selection switch 25 is also turned on. Therefore, the voltage-dividing capacitor 21 parallel-connected between the LED unit 11 and the ground discharges power to the LED unit 11 and the constant current controller 12 to stabilize the voltage between the LED unit 11 and the ground.

From the foregoing description, the present invention employs the voltage-dividing controller 30 to detect the voltage value V_{dc} of the pulsed DC power outputted from the rectification unit 10, and determines if the voltage-dividing capacitor 21 of the first series and parallel voltage divider 20 is connected in series to the LED unit 11 or is parallelly connected to the LED unit 11 and the constant current controller 12, so that the portion of the voltage value V_{dc} higher than the safe voltage threshold Vₛₑₜ is lowered and becomes a voltage drop across the voltage-dividing capacitor 21 of the first series and parallel voltage divider 20 to ensure that an average voltage of an input terminal and an output terminal of the constant current controller 12 is fixed at 48 V, which is the safe voltage threshold Vₛₑₜ. Moreover, suppose that the voltage-dividing capacitor 21 has power stored therein before the first series and parallel voltage divider 20 enters the parallel connection mode. When the voltage-dividing controller 30 controls the first series and parallel voltage divider 20 under the parallel connection mode and enables the voltage-dividing capacitor to be parallelly connected across the LED unit 11 and the ground, the voltage-dividing capacitor 21 will immediately discharge power to the LED unit 11 and the constant current controller 12 to stabilize the current flowing through the LED unit 11.

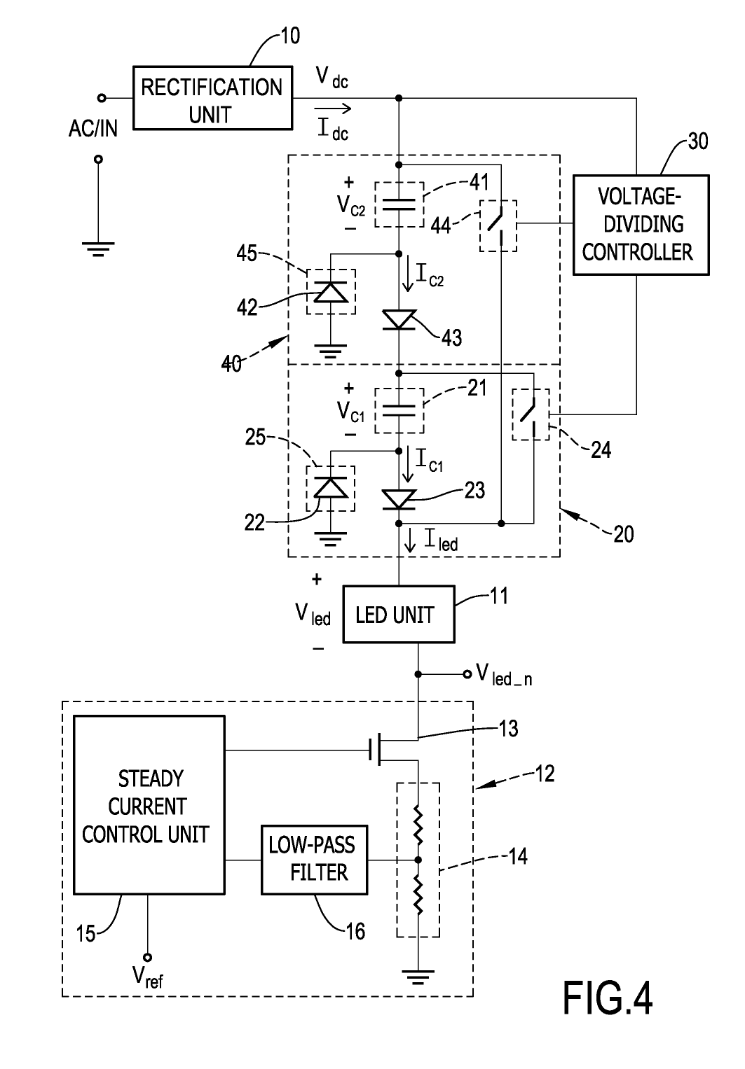

With reference to FIG. 4, a second embodiment of a linear LED driving circuit with voltage-lowering serial capacitor in accordance with the present invention differs from the foregoing embodiment in further having a second series and parallel voltage divider 40. The second series and parallel voltage divider 40 is connected between the rectification unit 10 and the first series and parallel voltage divider 20, is operated under a series connection mode or a parallel connection mode, and has a voltage-dividing capacitor 41. During the series connection mode, the voltage-dividing capacitor 41 is connected in series between the rectification unit 10 and the first series and parallel voltage divider 20. During the parallel connection mode, the voltage-dividing capacitor 41 is parallelly connected across the LED unit 11 and the ground. Furthermore, the voltage-dividing controller 30 is connected to the second series and parallel voltage divider 40, and is built in with a voltage switching threshold V_{sw}, which is not less than the safe voltage threshold Vₛₑₜ. The voltage-dividing controller 30 detects a voltage value V_{dc} of the pulsed DC power outputted from the rectification unit 10. The second series and parallel voltage divider 40 is controlled and operated under the series connection mode when the voltage value V_{dc} exceeds the voltage switching threshold V_{sw} and operated under the parallel connection mode when the voltage value V_{dc} does not exceed the voltage switching threshold V_{sw}. In the present embodiment, the voltage-dividing capacitor 41 has a positive end and a negative end, and the second series and parallel voltage divider 40 has a control diode 43, a first mode selection switch 44, and a second mode selection switch 45.

The control diode 43 is connected in series to the voltage-dividing capacitor 41 and has an anode and a cathode. The anode of the control diode 43 is connected to the negative end of the voltage-dividing capacitor 41.

The first mode selection switch 44 has two terminals. One terminal of the first mode selection switch 44 is connected to the positive end of the voltage-dividing capacitor 21, and the other terminal is connected to the LED unit 11. The voltage-dividing controller 30 is connected to the first mode selection switch 44. The voltage-dividing controller 30 turns off or on the first mode selection switch 44 when the voltage value V_{dc} of the pulsed DC power is or is not greater than the voltage switching threshold V.

The second mode selection switch 45 has two terminals. One terminal of the second mode selection switch 45 is connected to a series-connected node between the voltage-dividing capacitor 41 and the control diode 43, and the other terminal is connected to the ground. The voltage-dividing controller 30 is connected to the second mode selection switch 45. The voltage-dividing controller 30 turns off or on the first mode selection switch 44 when the voltage value V_{dc} of the pulsed DC power is or is not greater than the voltage switching threshold V_{sw}. In the present embodiment, the second mode selection switch 45 is a switching diode 42, whose cathode is connected to a series-connected node between the voltage-dividing capacitor 41 and the control diode 43, and whose anode is connected to the ground.

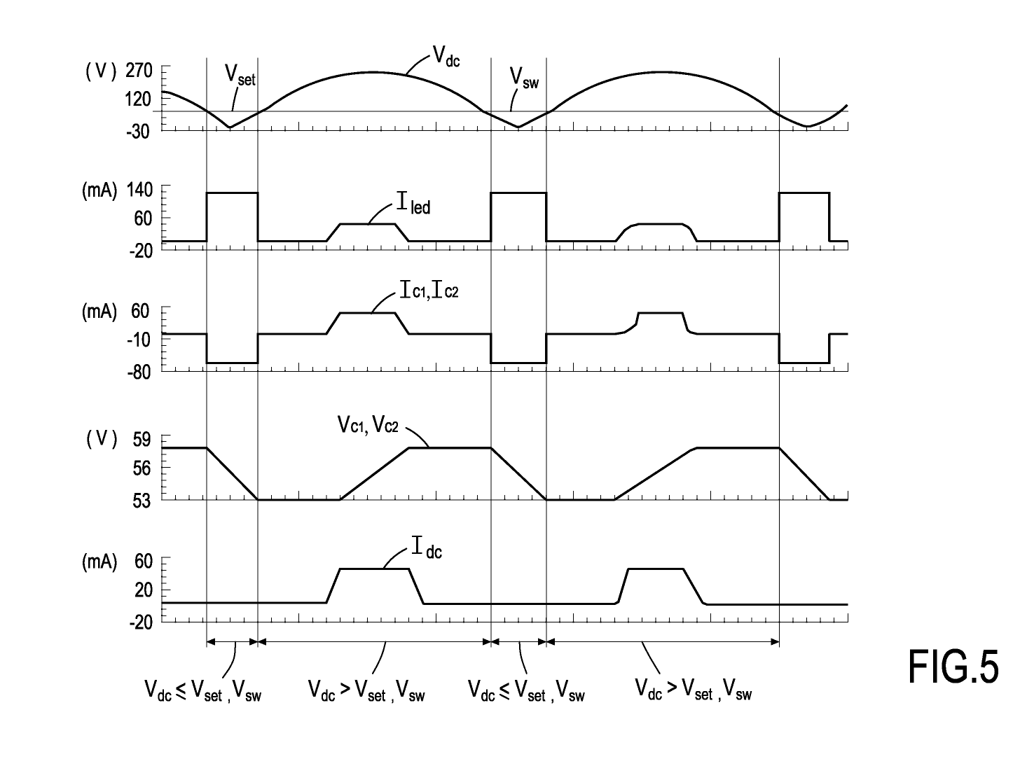

With reference to FIG. 5, suppose that an effective voltage value of the AC power source is 160 V, and the safe voltage threshold Vₛₑₜ and the voltage switching threshold are both 48 V. When the voltage value V_{dc} of the pulsed DC power is greater than the safe voltage threshold Vₛₑₜ and the voltage switching threshold V_{sw}, the voltage-dividing controller 30 turns off the first mode selection switches 24, 44 of the first and second series and parallel voltage dividers 20, 40. As the switching diodes 22, 42 of the second mode selection switches 25, 45 of the first and second series and parallel voltage dividers 20, 40 are reverse-biased at the same time, the second mode selection switches 25, 45 are also turned off. Therefore, the voltage-dividing capacitors 21, 41 of the first and second series and parallel voltage dividers 20, 40 are charged by the pulsed DC power and lower the voltage to the LED unit 11. When the voltage value V_{dc} of the pulsed DC power is not greater than the safe voltage threshold Vₛₑₜ and the voltage switching threshold V_{sw}, the voltage-dividing capacitors 21, 41 of the first and second series and parallel voltage dividers 20, 40 discharge power to the LED unit 11.

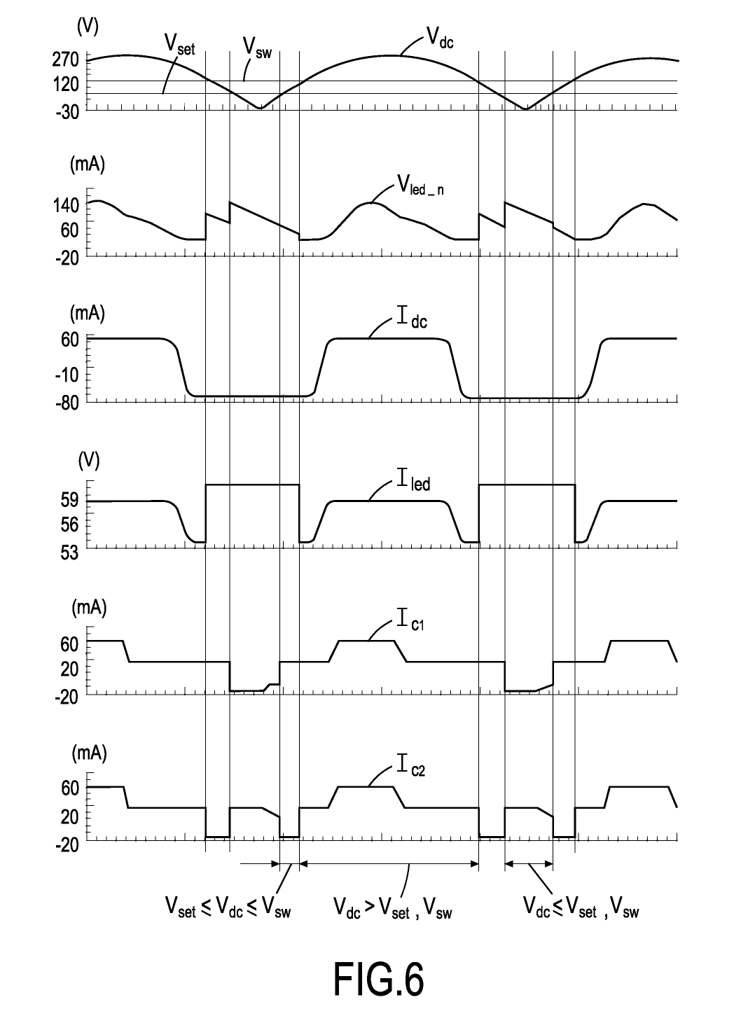

With reference to FIG. 6, suppose that an effective voltage value of the AC power source is 160 V and the safe voltage threshold Vₛₑₜ is 48 V and the voltage switching threshold is 96 V. When the voltage value V_{dc} of the pulsed DC power is greater than the safe voltage threshold Vₛₑₜ, the voltage-dividing controller 30 turns off the first mode selection switch 24 of the first series and parallel voltage divider 20 and simultaneously turns on the first mode selection switch 44 of the second series and parallel voltage divider 40. At the moment, the current I_{dc} of the pulsed DC power flows through the voltage-dividing capacitor 21 of the first series and parallel voltage divider 20 without flowing through the voltage-dividing capacitor 41 of the second series and parallel voltage divider 40. When the voltage value V_{dc} of the pulsed DC power is greater than the voltage switching threshold V_{sw}, the voltage-dividing controller 30 turns off the first mode selection switches 24, 44 of the first and second series and parallel voltage dividers 20, 40. A the moment, the current I_{dc} of the pulsed DC power flows through the voltage-dividing capacitors 21, 41 of the first and second series and parallel voltage dividers 20, 40. When the voltage value V_{dc} of the pulsed DC power is dropped between the safe voltage threshold Vₛₑₜ and the voltage switching threshold V_{sw}, the voltage-dividing controller 30 enables the voltage-dividing capacitor 41 of the second series and parallel voltage divider 40 parallelly connected across the LED unit 11 and the ground to discharge power. When the voltage value V_{dc} of the pulsed DC power is lower than the safe voltage threshold Vₛₑₜ and the voltage switching threshold V_{sw}, the voltage-dividing controller 30 enables the voltage-dividing capacitors 21, 41 of the first and second series and parallel voltage dividers 20, 40 parallelly connected across the LED unit 11 and the ground to discharge power.

As known from the foregoing description, the second embodiment of the present invention can selectively turn on or off the first mode selection switches 24, 44 according to variation of the voltage value V_{dc} of the pulsed DC power, thereby regulating and stabilizing the voltage between the LED unit 11 and the ground.

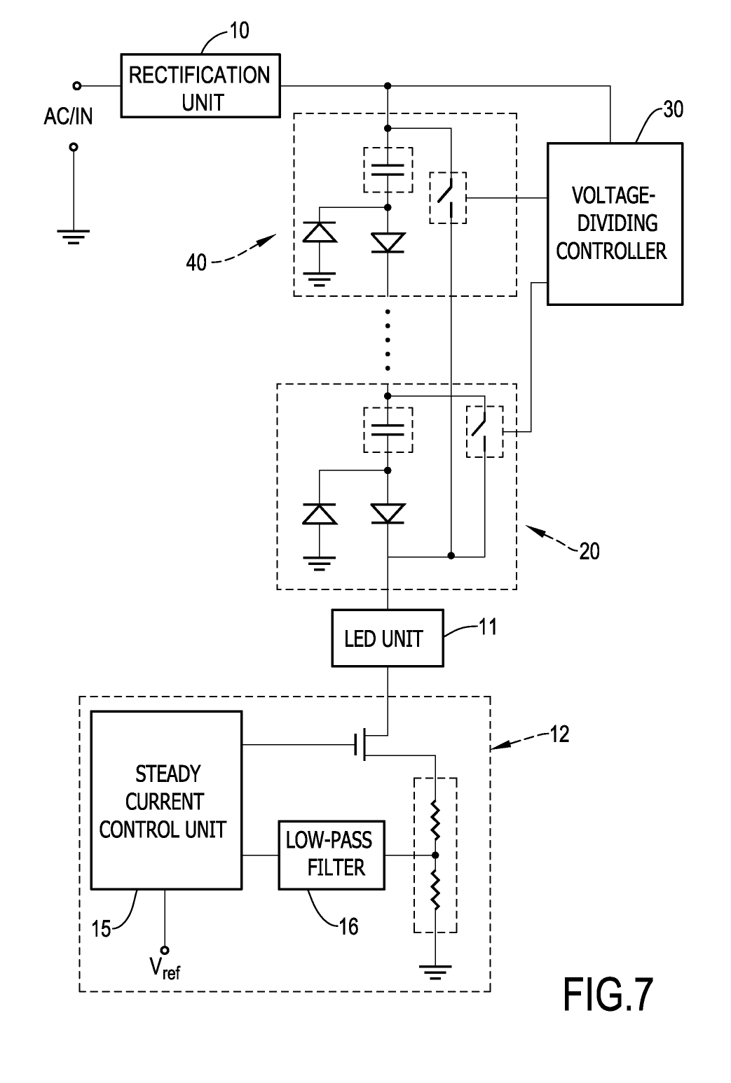

With reference to FIG. 7, a third embodiment of a linear LED driving circuit with voltage-lowering serial capacitor in accordance with the present invention is substantially the same as the second embodiment except that the present embodiment has multiple second series and parallel voltage dividers 40 connected in series between the rectification unit 10 and the first series and parallel voltage divider 20. As taught by the foregoing embodiment, the present invention can lower the voltage value V_{dc} of the pulsed DC power by series-connecting or parallel-connecting each voltage-dividing capacitor 21, 41, so as to stabilize the voltage between the LED unit 11 and the ground around the safe voltage threshold Vₛₑₜ. Given the present embodiment with multiple series-connected second series and parallel voltage dividers 40, the present invention can be applied to an AC power source (AC/IN) with even higher voltage.

In sum, the voltage-dividing capacitors 21, 41 can be connected in series between the rectification unit 10 and the LED unit 11 by switching the first mode selection switches 24, 44, so that the voltage between the LED unit 11 and the ground won't rise up because of the increase of the voltage value V_{dc} of the pulsed DC power. Alternatively, the voltage-dividing capacitors 21, 41 can be parallelly connected across the LED unit 11 and the ground to discharge power so that the voltage between the LED unit 11 and the ground can be stabilized. Accordingly, the present invention can eliminate the use of bulky and heavy transformer, ensure the compliance with the safety standard for LED driving circuit, and meet assorted voltage specifications of mains power.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A linear LED driving circuit with voltage-lowering serial capacitor, the linear LED driving circuit comprising:
a rectification unit adapted to connect to an AC power source and converting the AC power into a pulsed DC power;
a light-emitting diode (LED) unit connected in series to the rectification unit, and having multiple LED light sources;
a constant current controller connected in series to the LED unit and a ground to form a power loop, and maintaining current flowing through the LED unit at a constant value;
a first series and parallel voltage divider connected between the rectification unit and the LED unit, operated under a series connection mode or a parallel connection mode, and having a first voltage-dividing capacitor, wherein the first voltage-dividing capacitor is connected in series between the rectification unit and the LED unit during the series connection mode and is parallelly connected across the LED unit and the ground during the parallel connection mode; and
a voltage-dividing controller built in with a safe voltage threshold, connected to the rectification unit and the first series and parallel voltage divider, detecting a voltage value of the pulsed DC power outputted from the rectification unit, and controlling the first series and parallel voltage divider to be operated under the series connection mode when the voltage value of the pulsed DC voltage exceeds the safe voltage threshold and to be operated under the parallel connection mode when the voltage value of the pulsed DC voltage does not exceed the safe voltage threshold.

2. The linear LED driving circuit as claimed in claim 1, wherein
the first voltage-dividing capacitor has a positive end and a negative end; and
the first series and parallel voltage divider further has:
a control diode connected in series to the first voltage-dividing capacitor and having:
an anode connected to the negative end of the first voltage-dividing capacitor; and
a cathode;
a first mode selection switch having two terminals, one terminal of the first mode selection switch is connected to the positive end of the first voltage-dividing capacitor, and the other terminal of the first mode selection switch is connected to the LED unit; and
a second mode selection switch having two terminals, one terminal of the second mode selection switch is connected to a series-connected node between the first voltage-dividing capacitor and the control diode, and the other terminal of the second mode selection switch is connected to the ground.

3. The linear LED driving circuit as claimed in claim 2, wherein the second mode selection switch is a switching diode having a cathode connected to a series-connected node between the first voltage-dividing capacitor and the control diode, and an anode connected to the ground.

4. The linear LED driving circuit as claimed in claim 2, wherein
the voltage-dividing controller is connected to the first mode selection switch and the second mode selection switch;
the voltage-dividing controller turns off the first mode selection switch and the second mode selection switch when the first series and parallel voltage divider is operated under the series connection mode; and
the voltage-dividing controller turns on the first mode selection switch and the second mode selection switch when the first series and parallel voltage divider is operated under the parallel connection mode.

5. The linear LED driving circuit as claimed in claim 3, wherein
the voltage-dividing controller is connected to the first mode selection switch;
the voltage-dividing controller turns off the first mode selection switch when the first series and parallel voltage divider is operated under the series connection mode; and
the voltage-dividing controller turns on the first mode selection switch when the first series and parallel voltage divider is operated under the parallel connection mode.

6. The linear LED driving circuit as claimed in claim 1, further comprising:
at least one second series and parallel voltage divider connected between the rectification unit and the first series and parallel voltage divider, and operated under the series connection mode or the parallel connection mode, each one of the at least one second series and parallel voltage divider having a second voltage-dividing capacitor, wherein
the second voltage-dividing capacitor is connected in series between the rectification unit and the first series and parallel voltage divider during the series connection mode and is parallelly connected across the LED unit and the ground during the parallel connection mode; and
the voltage-dividing controller is connected to the at least one second series and parallel voltage divider, is built in with at least one voltage switching threshold being not less than the safe voltage threshold and adapted to correspond to a voltage value of at least one AC power source, and controls the second series and parallel voltage divider to be operated under the series connection mode when the voltage value of the pulsed DC power exceeds the at least one voltage switching threshold and operated under the parallel connection mode when the voltage value of the pulsed DC power does not exceed the at least one voltage switching threshold.

7. The linear LED driving circuit as claimed in claim 2, further comprising:
at least one second series and parallel voltage divider connected between the rectification unit and the first series and parallel voltage divider, and operated under the series connection mode or the parallel connection mode, each one of the at least one second series and parallel voltage divider having a second voltage-dividing capacitor, wherein
the second voltage-dividing capacitor is connected in series between the rectification unit and the first series and parallel voltage divider during the series connection mode and is parallelly connected across the LED unit and the ground during the parallel connection mode; and
the voltage-dividing controller is connected to the at least one second series and parallel voltage divider, is built in with at least one voltage switching threshold being not less than the safe voltage threshold and adapted to correspond to a voltage value of at least one AC power source, and controls the second series and parallel voltage divider to be operated under the series connection mode when the voltage value of the pulsed DC power exceeds the at least one voltage switching threshold and operated under the parallel connection mode when the voltage value of the pulsed DC power does not exceed the at least one voltage switching threshold.

8. The linear LED driving circuit as claimed in claim 3, further comprising:
at least one second series and parallel voltage divider connected between the rectification unit and the first series and parallel voltage divider, and operated under the series connection mode or the parallel connection mode, each one of the at least one second series and parallel voltage divider having a second voltage-dividing capacitor, wherein
the second voltage-dividing capacitor is connected in series between the rectification unit and the first series and parallel voltage divider during the series connection mode and is parallelly connected across the LED unit and the ground during the parallel connection mode; and
the voltage-dividing controller is connected to the at least one second series and parallel voltage divider, is built in with at least one voltage switching threshold being not less than the safe voltage threshold and adapted to correspond to a voltage value of at least one AC power source, and controls the second series and parallel voltage divider to be operated under the series connection mode when the voltage value of the pulsed DC power exceeds the at least one voltage switching threshold and operated under the parallel connection mode when the voltage value of the pulsed DC power does not exceed the at least one voltage switching threshold.

9. The linear LED driving circuit as claimed in claim 4, further comprising:
at least one second series and parallel voltage divider connected between the rectification unit and the first series and parallel voltage divider, and operated under the series connection mode or the parallel connection mode, each one of the at least one second series and parallel voltage divider having a second voltage-dividing capacitor, wherein
the second voltage-dividing capacitor is connected in series between the rectification unit and the first series and parallel voltage divider during the series connection mode and is parallelly connected across the LED unit and the ground during the parallel connection mode; and
the voltage-dividing controller is connected to the at least one second series and parallel voltage divider, is built in with at least one voltage switching threshold being not less than the safe voltage threshold and adapted to correspond to a voltage value of at least one AC power source, and controls the second series and parallel voltage divider to be operated under the series connection mode when the voltage value of the pulsed DC power exceeds the at least one voltage switching threshold and operated under the parallel connection mode when the voltage value of the pulsed DC power does not exceed the at least one voltage switching threshold.

10. The linear LED driving circuit as claimed in claim 5, further comprising:
at least one second series and parallel voltage divider connected between the rectification unit and the first series and parallel voltage divider, and operated under the series connection mode or the parallel connection mode, each one of the at least one second series and parallel voltage divider having a second voltage-dividing capacitor, wherein
the second voltage-dividing capacitor is connected in series between the rectification unit and the first series and parallel voltage divider during the series connection mode and is parallelly connected across the LED unit and the ground during the parallel connection mode; and
the voltage-dividing controller is connected to the at least one second series and parallel voltage divider, is built in with at least one voltage switching threshold being not less than the safe voltage threshold and adapted to correspond to a voltage value of at least one AC power source, and controls the second series and parallel voltage divider to be operated under the series connection mode when the voltage value of the pulsed DC power exceeds the at least one voltage switching threshold and operated under the parallel connection mode when the voltage value of the pulsed DC power does not exceed the at least one voltage switching threshold.

11. The linear LED driving circuit as claimed in claim 6, wherein the second voltage-dividing capacitor has a positive end and a negative end; and
each one of the at least one second series and parallel voltage divider further has:
a control diode connected in series to the second voltage-dividing capacitor and having:
an anode connected to the negative end of the second voltage-dividing capacitor; and
a cathode;
a first mode selection switch having two terminals, one terminal of the first mode selection switch of the second series and parallel voltage divider is connected to the positive end of the second voltage-dividing capacitor, and the other terminal of the first mode selection switch of the second series and parallel voltage divider is connected to the LED unit, wherein the voltage-dividing controller turns off the first mode selection switch of the second series and parallel voltage divider when the second series and parallel voltage divider is operated under the series connection mode, and the voltage-dividing controller turns on the first mode selection switch of the second series and parallel voltage divider when the first series and parallel voltage divider is operated under the parallel connection mode; and
a second mode selection switch having two terminals, one terminal of the second mode selection switch of the second series and parallel voltage divider is connected to a series-connected node between the second voltage-dividing capacitor and the control diode of the second series and parallel voltage divider, and the other terminal of the second mode selection switch of the second series and parallel voltage divider is connected to the ground, wherein the voltage-dividing controller turns off the second mode selection switch of the second series and parallel voltage divider when the second series and parallel voltage divider is operated under the series connection mode, and the voltage-dividing controller turns on the second mode selection switch of the second series and parallel voltage divider when the second series and parallel voltage divider is operated under the parallel connection mode.

12. The linear LED driving circuit as claimed in claim 7, wherein the second voltage-dividing capacitor has a positive end and a negative end; and
each one of the at least one second series and parallel voltage divider further has:
a control diode connected in series to the second voltage-dividing capacitor and having:
an anode connected to the negative end of the second voltage-dividing capacitor; and
a cathode;
a first mode selection switch having two terminals, one terminal of the first mode selection switch of the second series and parallel voltage divider is connected to the positive end of the second voltage-dividing capacitor, and the other terminal of the first mode selection switch of the second series and parallel voltage divider is connected to the LED unit, wherein the voltage-dividing controller turns off the first mode selection switch of the second series and parallel voltage divider when the second series and parallel voltage divider is operated under the series connection mode, and the voltage-dividing controller turns on the first mode selection switch of the second series and parallel voltage divider when the first series and parallel voltage divider is operated under the parallel connection mode; and
a second mode selection switch having two terminals, one terminal of the second mode selection switch of the second series and parallel voltage divider is connected to a series-connected node between the second voltage-dividing capacitor and the control diode of the second series and parallel voltage divider, and the other terminal of the second mode selection switch of the second series and parallel voltage divider is connected to the ground, wherein the voltage-dividing controller turns off the second mode selection switch of the second series and parallel voltage divider when the second series and parallel voltage divider is operated under the series connection mode, and the voltage-dividing controller turns on the second mode selection switch of the second series and parallel voltage divider when the second series and parallel voltage divider is operated under the parallel connection mode.

13. The linear LED driving circuit as claimed in claim 8, wherein the second voltage-dividing capacitor has a positive end and a negative end; and
each one of the at least one second series and parallel voltage divider further has:
a control diode connected in series to the second voltage-dividing capacitor and having:
an anode connected to the negative end of the second voltage-dividing capacitor; and
a cathode;
a first mode selection switch having two terminals, one terminal of the first mode selection switch of the second series and parallel voltage divider is connected to the positive end of the second voltage-dividing capacitor, and the other terminal of the first mode selection switch of the second series and parallel voltage divider is connected to the LED unit, wherein the voltage-dividing controller turns off the first mode selection switch of the second series and parallel voltage divider when the second series and parallel voltage divider is operated under the series connection mode, and the voltage-dividing controller turns on the first mode selection switch of the second series and parallel voltage divider when the first series and parallel voltage divider is operated under the parallel connection mode; and
a second mode selection switch having two terminals, one terminal of the second mode selection switch of the second series and parallel voltage divider is connected to a series-connected node between the second voltage-dividing capacitor and the control diode of the second series and parallel voltage divider, and the other terminal of the second mode selection switch of the second series and parallel voltage divider is connected to the ground, wherein the voltage-dividing controller turns off the second mode selection switch of the second series and parallel voltage divider when the second series and parallel voltage divider is operated under the series connection mode, and the voltage-dividing controller turns on the second mode selection switch of the second series and parallel voltage divider when the second series and parallel voltage divider is operated under the parallel connection mode.

14. The linear LED driving circuit as claimed in claim 9, wherein the second voltage-dividing capacitor has a positive end and a negative end; and
each one of the at least one second series and parallel voltage divider further has:
a control diode connected in series to the second voltage-dividing capacitor and having:
an anode connected to the negative end of the second voltage-dividing capacitor; and
a cathode;
a first mode selection switch having two terminals, one terminal of the first mode selection switch of the second series and parallel voltage divider is connected to the positive end of the second voltage-dividing capacitor, and the other terminal of the first mode selection switch of the second series and parallel voltage divider is connected to the LED unit, wherein the voltage-dividing controller turns off the first mode selection switch of the second series and parallel voltage divider when the second series and parallel voltage divider is operated under the series connection mode, and the voltage-dividing controller turns on the first mode selection switch of the second series and parallel voltage divider when the first series and parallel voltage divider is operated under the parallel connection mode; and
a second mode selection switch having two terminals, one terminal of the second mode selection switch of the second series and parallel voltage divider is connected to a series-connected node between the second voltage-dividing capacitor and the control diode of the second series and parallel voltage divider, and the other terminal of the second mode selection switch of the second series and parallel voltage divider is connected to the ground, wherein the voltage-dividing controller turns off the second mode selection switch of the second series and parallel voltage divider when the second series and parallel voltage divider is operated under the series connection mode, and the voltage-dividing controller turns on the second mode selection switch of the second series and parallel voltage divider when the second series and parallel voltage divider is operated under the parallel connection mode.

15. The linear LED driving circuit as claimed in claim 10, wherein the second voltage-dividing capacitor has a positive end and a negative end; and
each one of the at least one second series and parallel voltage divider further has:
a control diode connected in series to the second voltage-dividing capacitor and having:
an anode connected to the negative end of the second voltage-dividing capacitor; and
a cathode;
a first mode selection switch having two terminals, one terminal of the first mode selection switch of the second series and parallel voltage divider is connected to the positive end of the second voltage-dividing capacitor, and the other terminal of the first mode selection switch of the second series and parallel voltage divider is connected to the LED unit, wherein the voltage-dividing controller turns off the first mode selection switch of the second series and parallel voltage divider when the second series and parallel voltage divider is operated under the series connection mode, and the voltage-dividing controller turns on the first mode selection switch of the second series and parallel voltage divider when the first series and parallel voltage divider is operated under the parallel connection mode; and
a second mode selection switch having two terminals, one terminal of the second mode selection switch of the second series and parallel voltage divider is connected to a series-connected node between the second voltage-dividing capacitor and the control diode of the second series and parallel voltage divider, and the other terminal of the second mode selection switch of the second series and parallel voltage divider is connected to the ground, wherein the voltage-dividing controller turns off the second mode selection switch of the second series and parallel voltage divider when the second series and parallel voltage divider is operated under the series connection mode, and the voltage-dividing controller turns on the second mode selection switch of the second series and parallel voltage divider when the second series and parallel voltage divider is operated under the parallel connection mode.

16. The linear LED driving circuit as claimed in claim 11, wherein the second mode selection switch of the second series and parallel voltage divider is a switching diode having a cathode connected to a series-connected node between the second voltage-dividing capacitor and the control diode of the second series and parallel voltage divider, and an anode connected to the ground.

17. The linear LED driving circuit as claimed in claim 12, wherein the second mode selection switch of the second series and parallel voltage divider is a switching diode having a cathode connected to a series-connected node between the second voltage-dividing capacitor and the control diode of the second series and parallel voltage divider, and an anode connected to the ground.

18. The linear LED driving circuit as claimed in claim 13, wherein the second mode selection switch of the second series and parallel voltage divider is a switching diode having a cathode connected to a series-connected node between the second voltage-dividing capacitor and the control diode of the second series and parallel voltage divider, and an anode connected to the ground.

19. The linear LED driving circuit as claimed in claim 14, wherein the second mode selection switch of the second series and parallel voltage divider is a switching diode having a cathode connected to a series-connected node between the second voltage-dividing capacitor and the control diode of the second series and parallel voltage divider, and an anode connected to the ground.

20. The linear LED driving circuit as claimed in claim 15, wherein the second mode selection switch of the second series and parallel voltage divider is a switching diode having a cathode connected to a series-connected node between the second voltage-dividing capacitor and the control diode of the second series and parallel voltage divider, and an anode connected to the ground.

21. The linear LED driving circuit as claimed in claim 1, wherein the constant current controller has:
a voltage-controlled transistor connected in series to the LED unit to form the power loop;
a current-detecting unit connected in series to the voltage-controlled transistor, and detecting current flowing through the power loop; and
a steady current control unit connected to the voltage-controlled transistor and the current-detecting unit, reading a current signal detected by the current-detecting unit through a low-pass filter, and regulating the current flowing through the power loop via the voltage-controlled transistor according to the current signal.

22. The linear LED driving circuit as claimed in claim 2, wherein the constant current controller has:
a voltage-controlled transistor connected in series to the LED unit to form the power loop;
a current-detecting unit connected in series to the voltage-controlled transistor, and detecting current flowing through the power loop; and
a steady current control unit connected to the voltage-controlled transistor and the current-detecting unit, reading a current signal detected by the current-detecting unit through a low-pass filter, and regulating the current flowing through the power loop via the voltage-controlled transistor according to the current signal.

23. The linear LED driving circuit as claimed in claim 3, wherein the constant current controller has:
a voltage-controlled transistor connected in series to the LED unit to form the power loop;
a current-detecting unit connected in series to the voltage-controlled transistor, and detecting current flowing through the power loop; and
a steady current control unit connected to the voltage-controlled transistor and the current-detecting unit, reading a current signal detected by the current-detecting unit through a low-pass filter, and regulating the current flowing through the power loop via the voltage-controlled transistor according to the current signal.

24. The linear LED driving circuit as claimed in claim 4, wherein the constant current controller has:
a voltage-controlled transistor connected in series to the LED unit to form the power loop;
a current-detecting unit connected in series to the voltage-controlled transistor, and detecting current flowing through the power loop; and
a steady current control unit connected to the voltage-controlled transistor and the current-detecting unit, reading a current signal detected by the current-detecting unit through a low-pass filter, and regulating the current flowing through the power loop via the voltage-controlled transistor according to the current signal.

25. The linear LED driving circuit as claimed in claim 5, wherein the constant current controller has:
a voltage-controlled transistor connected in series to the LED unit to form the power loop;
a current-detecting unit connected in series to the voltage-controlled transistor, and detecting current flowing through the power loop; and
a steady current control unit connected to the voltage-controlled transistor and the current-detecting unit, reading a current signal detected by the current-detecting unit through a low-pass filter, and regulating the current flowing through the power loop via the voltage-controlled transistor according to the current signal.

26. The linear LED driving circuit as claimed in claim 6, wherein the constant current controller has:
a voltage-controlled transistor connected in series to the LED unit to form the power loop;
a current-detecting unit connected in series to the voltage-controlled transistor, and detecting current flowing through the power loop; and
a steady current control unit connected to the voltage-controlled transistor and the current-detecting unit, reading a current signal detected by the current-detecting unit through a low-pass filter, and regulating the current flowing through the power loop via the voltage-controlled transistor according to the current signal.

27. The linear LED driving circuit as claimed in claim 7, wherein the constant current controller has:
a voltage-controlled transistor connected in series to the LED unit to form the power loop;
a current-detecting unit connected in series to the voltage-controlled transistor, and detecting current flowing through the power loop; and
a steady current control unit connected to the voltage-controlled transistor and the current-detecting unit, reading a current signal detected by the current-detecting unit through a low-pass filter, and regulating the current flowing through the power loop via the voltage-controlled transistor according to the current signal.

28. The linear LED driving circuit as claimed in claim 8, wherein the constant current controller has:
a voltage-controlled transistor connected in series to the LED unit to form the power loop;
a current-detecting unit connected in series to the voltage-controlled transistor, and detecting current flowing through the power loop; and
a steady current control unit connected to the voltage-controlled transistor and the current-detecting unit, reading a current signal detected by the current-detecting unit through a low-pass filter, and regulating the current flowing through the power loop via the voltage-controlled transistor according to the current signal.

29. The linear LED driving circuit as claimed in claim 9, wherein the constant current controller has:
a voltage-controlled transistor connected in series to the LED unit to form the power loop;
a current-detecting unit connected in series to the voltage-controlled transistor, and detecting current flowing through the power loop; and
a steady current control unit connected to the voltage-controlled transistor and the current-detecting unit, reading a current signal detected by the current-detecting unit through a low-pass filter, and regulating the current flowing through the power loop via the voltage-controlled transistor according to the current signal.

30. The linear LED driving circuit as claimed in claim 10, wherein the constant current controller has:
a voltage-controlled transistor connected in series to the LED unit to form the power loop;
a current-detecting unit connected in series to the voltage-controlled transistor, and detecting current flowing through the power loop; and
a steady current control unit connected to the voltage-controlled transistor and the current-detecting unit, reading a current signal detected by the current-detecting unit through a low-pass filter, and regulating the current flowing through the power loop via the voltage-controlled transistor according to the current signal.

31. The linear LED driving circuit as claimed in claim 11, wherein the constant current controller has:
a voltage-controlled transistor connected in series to the LED unit to form the power loop;
a current-detecting unit connected in series to the voltage-controlled transistor, and detecting current flowing through the power loop; and
a steady current control unit connected to the voltage-controlled transistor and the current-detecting unit, reading a current signal detected by the current-detecting unit through a low-pass filter, and regulating the current flowing through the power loop via the voltage-controlled transistor according to the current signal.

32. The linear LED driving circuit as claimed in claim 12, wherein the constant current controller has:
a voltage-controlled transistor connected in series to the LED unit to form the power loop;
a current-detecting unit connected in series to the voltage-controlled transistor, and detecting current flowing through the power loop; and
a steady current control unit connected to the voltage-controlled transistor and the current-detecting unit, reading a current signal detected by the current-detecting unit through a low-pass filter, and regulating the current flowing through the power loop via the voltage-controlled transistor according to the current signal.

33. The linear LED driving circuit as claimed in claim 13, wherein the constant current controller has:
a voltage-controlled transistor connected in series to the LED unit to form the power loop;
a current-detecting unit connected in series to the voltage-controlled transistor, and detecting current flowing through the power loop; and
a steady current control unit connected to the voltage-controlled transistor and the current-detecting unit, reading a current signal detected by the current-detecting unit through a low-pass filter, and regulating the current flowing through the power loop via the voltage-controlled transistor according to the current signal.

34. The linear LED driving circuit as claimed in claim 14, wherein the constant current controller has:
a voltage-controlled transistor connected in series to the LED unit to form the power loop;
a current-detecting unit connected in series to the voltage-controlled transistor, and detecting current flowing through the power loop; and
a steady current control unit connected to the voltage-controlled transistor and the current-detecting unit, reading a current signal detected by the current-detecting unit through a low-pass filter, and regulating the current flowing through the power loop via the voltage-controlled transistor according to the current signal.

35. The linear LED driving circuit as claimed in claim 15, wherein the constant current controller has:
a voltage-controlled transistor connected in series to the LED unit to form the power loop;
a current-detecting unit connected in series to the voltage-controlled transistor, and detecting current flowing through the power loop; and
a steady current control unit connected to the voltage-controlled transistor and the current-detecting unit, reading a current signal detected by the current-detecting unit through a low-pass filter, and regulating the current flowing through the power loop via the voltage-controlled transistor according to the current signal.

36. The linear LED driving circuit as claimed in claim 16, wherein the constant current controller has:
a voltage-controlled transistor connected in series to the LED unit to form the power loop;
a current-detecting unit connected in series to the voltage-controlled transistor, and detecting current flowing through the power loop; and
a steady current control unit connected to the voltage-controlled transistor and the current-detecting unit, reading a current signal detected by the current-detecting unit through a low-pass filter, and regulating the current flowing through the power loop via the voltage-controlled transistor according to the current signal.

37. The linear LED driving circuit as claimed in claim 17, wherein the constant current controller has:
a voltage-controlled transistor connected in series to the LED unit to form the power loop;
a current-detecting unit connected in series to the voltage-controlled transistor, and detecting current flowing through the power loop; and
a steady current control unit connected to the voltage-controlled transistor and the current-detecting unit, reading a current signal detected by the current-detecting unit through a low-pass filter, and regulating the current flowing through the power loop via the voltage-controlled transistor according to the current signal.

38. The linear LED driving circuit as claimed in claim 18, wherein the constant current controller has:
a voltage-controlled transistor connected in series to the LED unit to form the power loop;
a current-detecting unit connected in series to the voltage-controlled transistor, and detecting current flowing through the power loop; and
a steady current control unit connected to the voltage-controlled transistor and the current-detecting unit, reading a current signal detected by the current-detecting unit through a low-pass filter, and regulating the current flowing through the power loop via the voltage-controlled transistor according to the current signal.

39. The linear LED driving circuit as claimed in claim 19, wherein the constant current controller has:
a voltage-controlled transistor connected in series to the LED unit to form the power loop;
a current-detecting unit connected in series to the voltage-controlled transistor, and detecting current flowing through the power loop; and
a steady current control unit connected to the voltage-controlled transistor and the current-detecting unit, reading a current signal detected by the current-detecting unit through a low-pass filter, and regulating the current flowing through the power loop via the voltage-controlled transistor according to the current signal.

40. The linear LED driving circuit as claimed in claim 20, wherein the constant current controller has:
a voltage-controlled transistor connected in series to the LED unit to form the power loop;
a current-detecting unit connected in series to the voltage-controlled transistor, and detecting current flowing through the power loop; and
a steady current control unit connected to the voltage-controlled transistor and the current-detecting unit, reading a current signal detected by the current-detecting unit through a low-pass filter, and regulating the current flowing through the power loop via the voltage-controlled transistor according to the current signal.
